(19) United States
(12) Patent Application Publication
(10) Pub. No.: US 2006/0099378 A1
(43) Pub. Date: May 11, 2006

(54) Method for connection between composite material and fixing element and structure thereof

(75) Inventors: Ching-Cheng Wang, Kuei Shan Hsiang (TW); Chao-Hung Lin, Kuei Shan Hsiang (TW); Jung-Wen Chang, Lu Chu Hsiang (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Quanta Computer Inc.

(21) Appl. No.: 11/139,213

(22) Filed: May 27, 2005

(30) Foreign Application Priority Data
Nov. 11, 2004 (TW) 93134427

(51) Int. Cl. B44C 1/26

(52) U.S. Cl. 428/67

(57) ABSTRACT

A method for connection between composite material and the step of method between composite material comprises (a) gluing a fixing element to a mold and generating a gap between the fixing element and the mold, (b) filling a liquid epoxy in the gap, (c) contacting a composite material with the fixing element and the liquid epoxy simultaneously, (d) solidifying the liquid epoxy, and (e) separating the mold from the fixing element. Connection structure between composite materials comprises a fixing element, an epoxy, and a composite material. The fixing element comprises a first contact surface. The composite material comprises a second contact surface. The first and the second connect surface connecting each other via the epoxy are not adhered by the epoxy.

### BACKGROUND

The invention relates in general to a method for connection between a composite material and a fixing element and a structure thereof.

A composite material is composed of at least two different kinds of material. Because a composite material is light, hard, and appears to be of high quality, it often replaces metal.

When a composite material is applied in a product having a thin housing, one concern is how to fix a composite material thereon via a fixing element. If a composite material is drilled for fastening with a thin housing the composite material may be damaged shorten lifespan thereof.

Moreover, direct connection of the fixing element and the composite material is easily separable.

### SUMMARY

The invention provides a method for connection between a composite material and a fixing element and a structure thereof. The method of connecting a composite material and a fixing element comprises: gluing a fixing element to a mold and generating a gap between the fixing element and the mold; filling the gap with a liquid epoxy; contacting a composite material with the fixing element and the epoxy in liquid state simultaneously; solidifying the liquid epoxy; and separating the mold from the fixing element.

The connection of a composite material and a fixing element comprises a fixing element comprising a first contact surface, a composite material comprising a second contacting surface contact a first contact surface, and a fastening glue not positioned between the first contact surface and the second contact surface but contacting the fixing element and the composite material only for fastening the fixing element on the composite material. When the fixing element and the composite material are manufactured, the connection between the fixing element and the composite material can maintain the strength of the composite material.

### BRIEF DESCRIPTION OF THE DRAWINGS

The present invention can be more fully understood by reading the subsequent detailed description and examples with references made to the accompanying drawings, wherein:

FIG. 1 is a flow chart of the invention;

FIGS. 2 to 6 are diagrams of the connection steps of an embodiment;

FIG. 7 is a diagram of another embodiment;

FIG. 8 is a diagram of another embodiment;

FIG. 9 is a diagram of another embodiment; and

FIG. 10 is a diagram of another embodiment.

### DETAILED DESCRIPTION

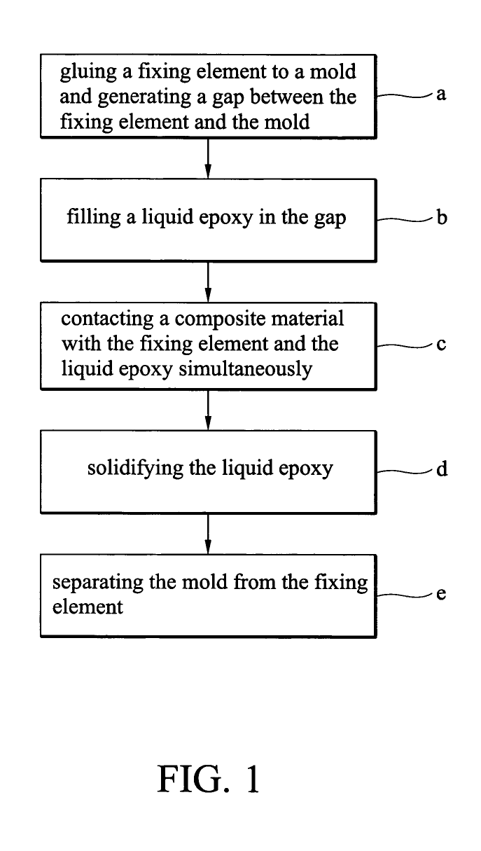

FIG. 1 is a flow chart of this invention. First a fixing element 10 is glued to a mold 20 and a gap 23 is generated therebetween (FIG. 3). A liquid epoxy 30 is then filled in the gap 23 (FIG. 4). A composite material 40 contacts the fixing element 10. The liquid epoxy 30 is then solidified by heating (FIG. 5). Finally, the mold 20 is separated from the fixing element 10 (FIG. 6).

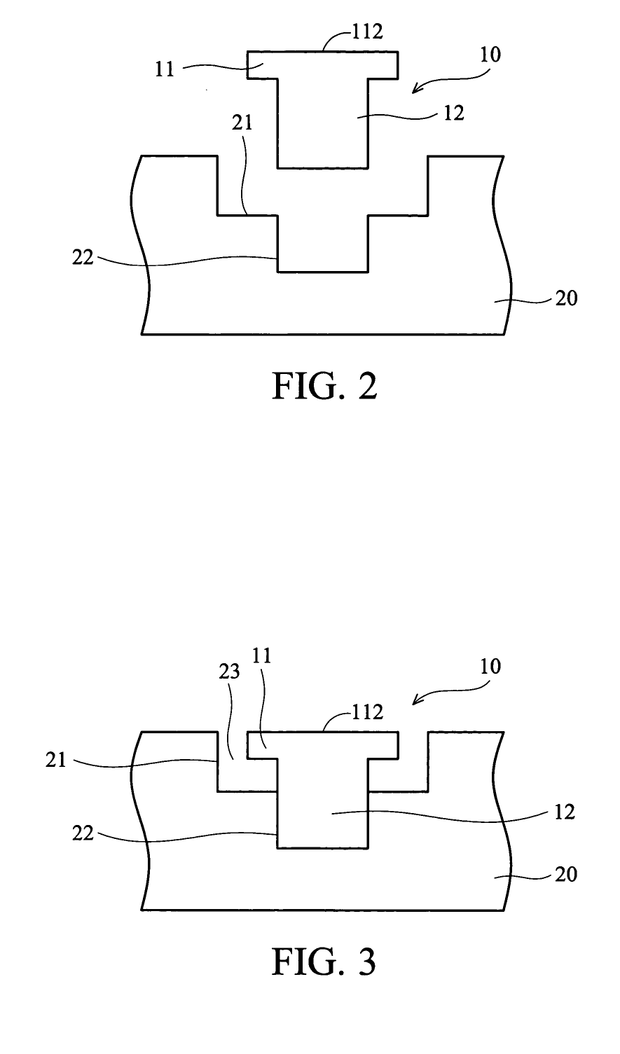

Referring to FIGS. 2, 3 and 4, the fixing element 10 comprises a prop end 11 and a fixed end 12. The mold 20 comprises a recess 21 and a hole 22. The fixed end 12 is disposed in the hole 22. The prop end 11 is disposed in the recess 21. Because the prop end 11 is smaller than the recess 21, a gap 23 is generated between the prop end 11 and the recess. The epoxy 30 in liquid state fills the gap 23. In this embodiment, the fixing element 10 can be a nail.

Referring to FIGS. 5 and 6, the epoxy 30 is a thermosetting epoxy. After epoxy 30 in liquid state fills the gap 23, the epoxy 30 connects the composite material 40 and the prop end 11. Then, the epoxy 30 is solidified via heating. The fixing element 10 is fixed to the composite material 40 via the caking power of the epoxy 30. Finally, the mold 20 is separated from the fixing element 10. The prop end 11 of the fixing element 10 comprises a first contact surface 112 and the composite material 40 comprises a second contact surface 41 connecting the first contact surface 112. The epoxy 30 is applied to the fixing element 10 and the composite material 40 without contacting the first contact surface 112 and the second contact surface 41.

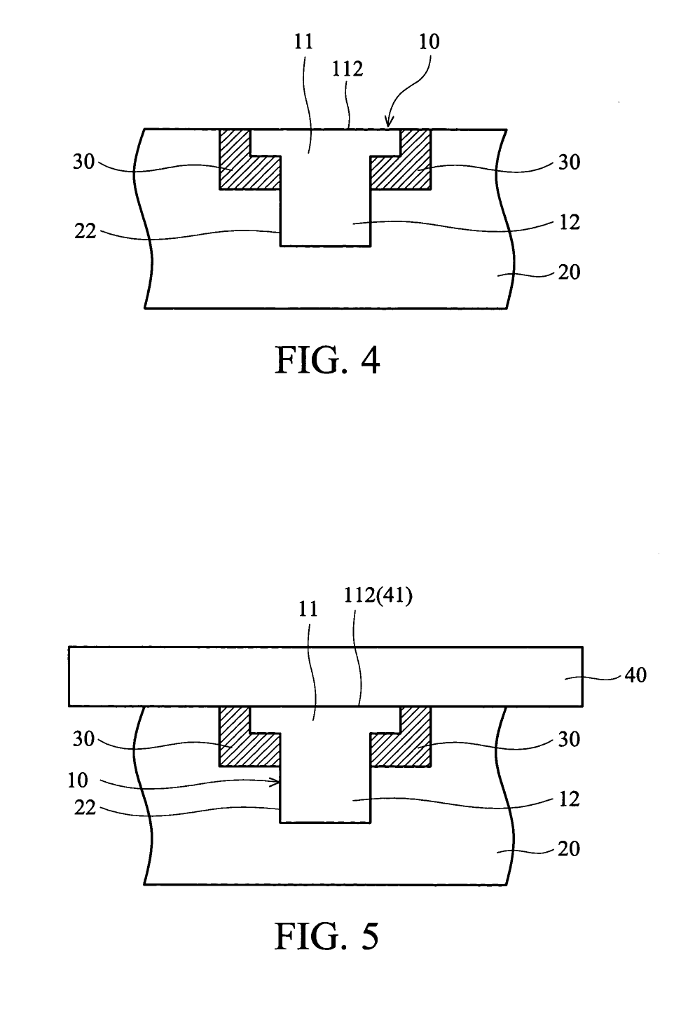

FIG. 7 illustrates another embodiment which is similar to the foregoing embodiment. The difference is a recess 21′ which is a stepped recess is provided. The stepped recess 21′ can increase connection area between the epoxy 30, the composite material 40 and the fixing element 10 to improve adhesion of the epoxy 30.

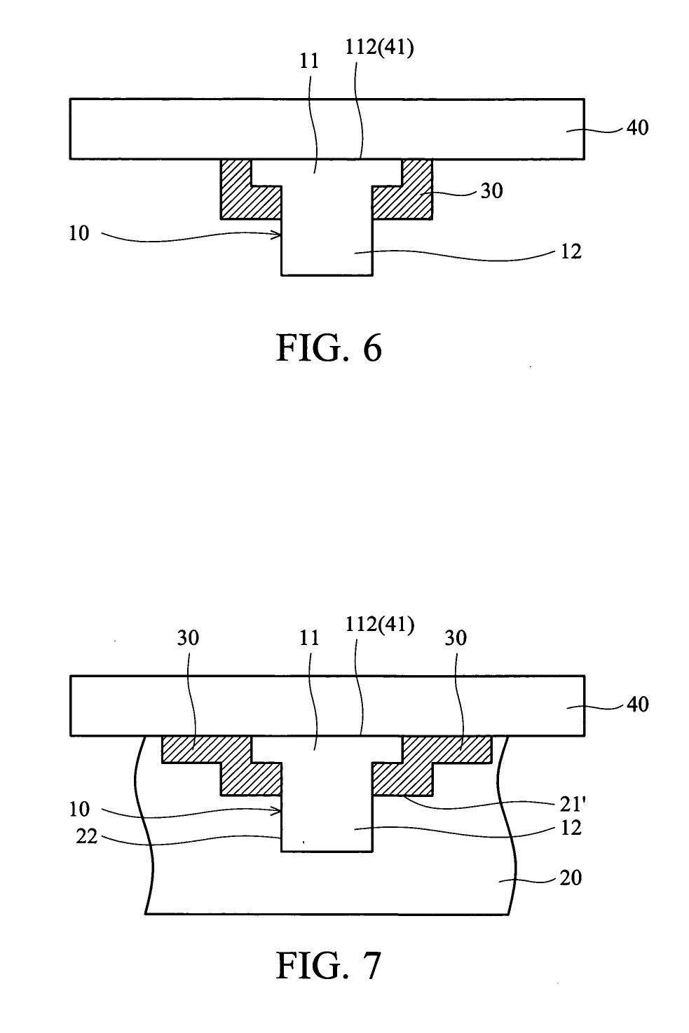

FIG. 8 illustrates another embodiment which is similar to the foregoing embodiment of FIG. 5. The difference is that a recess 21″ is a trapezoidal recess, and a prop end 11′ comprises an indentation 111′. Sides of the prop end 11′ are embossed. The indentation is V-shaped. This embodiment increases friction to raise the caking power of the epoxy 30 by increasing the connection area and surface roughness.

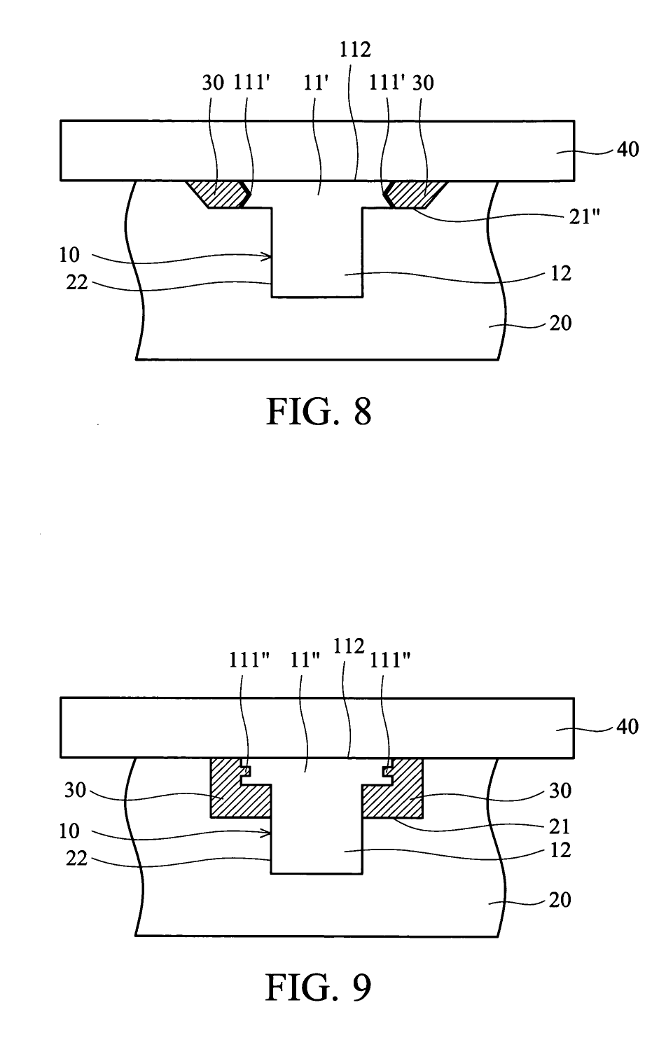

FIG. 9 illustrates another embodiment which is similar to the foregoing embodiment of FIG. 5. The difference is that a recess 21″ is a trapezoidal recess, and a prop end 11″ comprises an indentation 111″. The indentation 111″ is rectangular. This embodiment improves the caking power of the epoxy 30 to adhere to the fixing element 10 by increasing connection area.

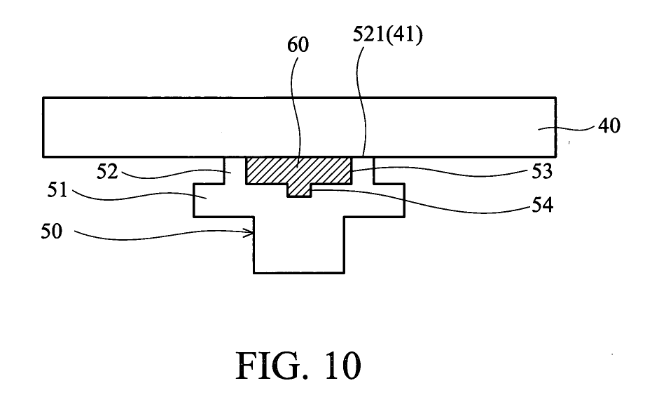

Referring to FIG. 10, the fixing element 50 comprises a prop end 51, a protrusion 52, a first sunken portion 53, and a second sunken portion 54. The protrusion 52 is positioned on the prop end 51 to form the first sunken portion 53 and a first connecting surface 521. A fastening glue 60 fills in the first sunken portion 53 and a second sunken portion 54. By using the connecting method disclosed in FIG. 1, the composite material 40 is adhered to the fixing element 50 via the fastening glue 60. The fastening glue 60 does not contact the first contacting surface 521 positioned on the prop end 51 and the second contacting surface 41 positioned on the composite material 40.

While the invention has been described by way of example and in terms of the preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method of connecting a composite material and a fixing element, comprising:
gluing a fixing element to a mold and generating a gap between the fixing element and the mold;
filling a liquid epoxy in the gap;
contacting a composite material with the fixing element and the liquid epoxy simultaneously;
solidifying the liquid epoxy; and
separating the mold from the fixing element.

2. The method of connecting a composite material and a fixing element as claimed in claim 1, wherein the mold comprises a hole holding the fixing element.

3. The method of connecting a composite material and a fixing element as claimed in claim 2, wherein the fixing element comprises a prop end and a fixed end connected to the prop end, and the mold comprises a recess, the hole located in the recess, the prop end and the gap positioned therebetween.

4. The method of connecting a composite material and a fixing element as claimed in claim 3, wherein the composite material contacts the prop end.

5. The connection structure of a composite material and a fixing element, comprising:
a fixing element comprising a first contact surface;
a composite material comprising a second contact surface contacting the first contact surface; and
a fastening glue contacting to the fixing element and the composite material without contacting the first contact surface and the second contact surface for fastening the fixing element to the composite material.

6. The connection structure of a composite material and a fixing element as claimed in claim 5, wherein the fixing element further comprises a prop end having the first contact surface, and a fixed end connecting to the prop end.

7. The connection structure of a composite material and a fixing element as claimed in claim 6, wherein the fastening glue surrounds the prop end.

8. The connection of a composite material and a fixing element as claimed in claim 7, wherein the fixing element further comprises an indentation.

9. The connection structure of a composite material and a fixing element as claimed in claim 8, wherein a part of the fastening glue is filled in the indentation.

10. The connection structure of a composite material and a fixing element as claimed in claim 8, wherein the indentation is V-shaped.

11. The connection structure of a composite material and a fixing element as claimed in claim 8, wherein the indentation is rectangular.

12. The connection structure of a composite material and a fixing element as claimed in claim 8, wherein the indentation comprises an embossed pattern.

13. The connection structure of a composite material and a fixing element as claimed in claim 6, wherein the fixing element further comprises a first sunken portion positioned on the prop end, and the fastening glue positioned therein.

14. The connection structure of a composite material and a fixing element as claimed in claim 13, wherein the fixing element further comprises a second sunken portion positioned in the first sunken portion, and the fastening glue positioned therein.

15. The connection structure of a composite material and a fixing element as claimed in claim 5, wherein the fastening glue comprises an epoxy.
